(19) United States
(12) Patent Application Publication
(10) Pub. No.: US 2014/0125427 A1
(43) Pub. Date: May 8, 2014

(54) WIDE BAND SUM & DIFFERENCE CIRCUIT FOR MONOLITHIC MICROWAVE INTEGRATED CIRCUIT

(71) Applicant: ELECTRONICS AND TELECOMMUNICATIONS RESEARCH INSTITUTE, Daejeon (KR)

(72) Inventors: Seong Mo MOON, Daejeon (KR); Dong Hwan SHIN, Daejeon (KR); In Bok YOM, Daejeon (KR)

(73) Assignee: Electronics and Telecommunications Research Institute, Daejeon (KR)

(21) Appl. No.: 13/744,309

(22) Filed: Jan. 17, 2013

(30) Foreign Application Priority Data
Nov. 5, 2012 (KR) 10-2012-0124280

(51) Int. Cl. H01P 5/22

(52) U.S. Cl. CPC H01P 5/222
USPC 333/117

(57) ABSTRACT

Disclosed is a wide band sum & difference circuit for a monolithic microwave integrated circuit according to an exemplary embodiment of the present invention. The wide band sum & difference circuit for a monolithic microwave integrated circuit according to an exemplary embodiment of the present invention, including: a Range coupler having one terminal connected to a plurality of first ports that receive a signal and the other terminal connected to a plurality of second ports that output signals; one λ/4 line that is connected between one output terminal and one second port of the Range coupler in series; and one short stub λ/4 line that is connected with the other output terminal and the other second port of the Range coupler in parallel.

### CROSS-REFERENCE TO RELATED APPLICATIONS

This application claims priority to and the benefit of Korean Patent Application No. 10-2012-0124280 filed in the Korean Intellectual Property Office on Nov. 5, 2012, the entire contents of which are incorporated herein by reference.

### TECHNICAL FIELD

The present invention relates to a sum & difference circuit operated like a rat race coupler, and more particularly, to a wide band sum & difference circuit for a monolithic microwave integrated circuit configured to include one Range coupler and one λ/4 line and further include a short stub line or a resonance circuit as needed.

### BACKGROUND ART

A microwave band and a millimeter wave band are attractive frequency bands currently available for numerous applications due to saturation of a low frequency band and a possible provision of a wide frequency band reaching several GHz to several tens of GHz. Subsequently, implementation of an inexpensive microwave and millimeter wave system has increased due to the sudden increase in an operating speed of devices used in a process for a monolithic microwave integrated circuit (MMIC).

However, in case of a system developed until now, in manufacturing the system into one chip, including the passive circuit, a size of the passive circuit is too large, such that a space of an IC circuit may be wasted or insufficient. A representative example of a high frequency passive circuit wasting a space may include a ring-hybrid, a Wilkinson power divider, and a Rat-race coupler.

FIG. 1 illustrates a general rat-race coupler implemented as a micro strip line.

As illustrated in FIG. 1, intervals between ports P1 and P2, P2 and P3, and P3 and P4 are spaced apart from each other by λ/4 and only an interval between ports P1 to P4 is spaced apart from each other by λ/4. The input and output relationship between respective ports is defined by the deposition.

When a signal is input to the P3, a wave propagated through a ring from the P3 at about 5λ/4 clockwise and a wave propagated through a ring from P3 at λ/4 counterclockwise reach the P2. Since the reached two waves have the same phase, the summed waves are output to the P2. Like the P2, the waves summed clockwise and counterclockwise are output to the P4. The wave propagated from the P3 at λ clockwise and the wave propagated from the P3 at λ/2 counterclockwise reach the P1. Since the two waves have an opposite phase to each other, the two waves are offset from each other, such that the P1 becomes isolation at which no output is detected. Therefore, the P1 becomes a totally unrelated port and thus, when viewing from the P3, seems to be a circuit in which two ports, that is, the P2 and the P4 are disposed to be symmetrical with each other. That is, power input to the P3 is equally distributed to the P2 and P4 halves in the same phase. FIG. 2 illustrates output waveforms at each port when a signal is input to the P3. FIG. 3 illustrates waveforms having a phase difference in the outputs of the P2 and the P4 when a signal is input to the P3.

When a signal is input to the P1, a wave propagated through a ring from the P1 at about 5λ/4 clockwise and a wave propagating a ring from P1 at λ/4 counterclockwise reach the P2. Since the reached two waves have the same phase, the summed waves are output to the P2. When viewing from the P1, in both the clockwise direction and the counterclockwise direction, the P4 is at a position of 3λ/4, such that the waves having the same phase are summed and output. The wave propagated from the P3 (“P1”) at λ/2 clockwise and the wave propagated from the P3 at λ counterclockwise reach the P3. Since the two waves have the opposite phase to each other, the two waves are offset from each other, such that the P3 becomes isolation from the P1. Therefore, the P3 becomes a totally unrelated port and thus, when viewing from the P1, seems to be a circuit in which two ports, that is, the P2 and the P4 are disposed to be symmetrical with each other. However, the input power of the P1 is equally distributed to the P2 and the P4, but the P2 and the P4 are an antiphase (180°) to each other. FIG. 4 illustrates output waveforms at each port when a signal is input to the P3. FIG. 5 illustrates a waveform having a phase difference in outputs of the P2 and the P4 when a signal is input to the P3.

FIG. 6 illustrates an example in which the general rat-race coupler is configured in an integrated circuit As illustrated in FIG. 6, in order to configure the general rat-race coupler as illustrate in FIG. 1 in the integrated circuit, three λ/4 lines and one 3λ/4 are needed and therefore, even in 20 GHz, the circuit within the chip is too large a size to be implemented in the MMIC. In order to reduce the size, a method for reducing the circuit size by applying a meander scheme to a λ/4 line 610 has been used, but considering a dielectric constant and a height of a substrate in most of MIMIC (“MMIC”) processes, it is difficult to reduce the circuit size even in case of using the meander scheme.

FIG. 7 illustrates the general rat-race coupler implemented as a short stub line so as for the general rat-race coupler to be operated in a wide band. FIG. 8 illustrates an example in which the general rat-race coupler is implemented to be operated in a wide band. As illustrated in FIG. 7, two short stub λ/4 lines are used so as for the general rat-race coupler to be operated in a wide band. As can be appreciated from FIG. 8, so as for the general rat-race coupler to be operated in the wide band, there is a need to increase a space within a chip.

### SUMMARY OF THE INVENTION

The present invention has been made in an effort to provide a wide band sum & difference circuit for a monolithic microwave integrated circuit configured to have the same characteristics as a rat-race coupler, including one Range coupler and one λ/4 line and further include a short stub line or a resonance circuit as needed. However, objects of the present invention are not limited the above-mentioned matters and other objects can be clearly understood to those skilled in the art from the following descriptions.

An exemplary embodiment of the present invention a wide band sum & difference circuit for a monolithic microwave integrated circuit, including: a Range coupler having one terminal connected to a plurality of first ports that receive a signal and the other terminal connected to a plurality of second ports that output signals; one λ/4 line that is connected between one output terminal and one second port of the Range coupler in series; and one short stub λ/4 line that is connected with the other output terminal and the other second port of the Range coupler in parallel.

The first port may include: an input port that receives the signal; and an isolated port at which no output signal is detected when the signal is input to the input port.

The second port may include: a through port that outputs a predetermined ratio of the input signal when the signal is input to the input port; and a coupled port that outputs the predetermined ratio of the input signal when the signal is input to the input port.

The short stub λ/4 line may be substituted into one short stub λ/8 line and one open stub λ/8 line that are connected between the other output terminal and the other second port of the Range coupler in parallel.

The short stub λ/4 line may be substituted into a resonance circuit that is connected between the other output terminal and the other second port of the Range coupler in parallel.

The resonance circuit may be an LC parallel resonance circuit.

Power input to any one of the plurality of first ports may be equally distributed to each of the two of the plurality of second ports halves and have the same phase (0°) or an antiphase (180°).

As set forth above, according to the exemplary embodiments of the present invention, it is possible to solve the problem in that the space of the IC chip is wasted or insufficient, by including the one Range coupler and the one λ/4 line and further including the short stub line or the resonance circuit as needed.

According to the exemplary embodiments of the present invention, it is possible to manufacture the small wide band sum & difference circuit, by including the one Range coupler and the one λ/4 line and further including the short stub line or the resonance circuit as needed.

According to the exemplary embodiments of the present invention, it is possible to reduce the manufacturing processes, such as the manufacturing at the external substrate, the coupling with the inside of the IC chip, and the like, when being manufactured together with other radio frequency (RF) circuits, by implementing the integration within the IC chip by including the one Range coupler and the one λ/4 line and further including the short stub line or the resonance circuit as needed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a general rat-race coupler implemented as a micro strip line.

FIG. 2 is a diagram illustrating output waveforms at each port when a signal is input to a P3.

FIG. 3 illustrates waveforms having a phase difference in the outputs of a P2 and a P4 when the signal is input the P3.

FIG. 4 is a diagram illustrating output waveforms at each port when a signal is input to a P3.

FIG. 5 illustrates the waveforms having the phase difference in the outputs of the P2 and the P4 when the signal is input the P3.

FIG. 6 is a diagram illustrating an example in which a general rat-race coupler is configured in an integrated circuit.

FIG. 7 is a diagram illustrating the general rat-race coupler implemented as a short stub line.

FIG. 8 is a diagram illustrating an example in which the general rat-race coupler is implemented to be operated in a wide band.

FIG. 9 is a diagram illustrating a narrow band sum & difference circuit in accordance with an exemplary embodiment of the present invention.

FIG. 10 is a diagram illustrating output waveforms at each port when the signal is input to the P3.

FIG. 11 is a first diagram illustrating the waveforms in the phase difference of the outputs of the P2 and the P4 when the signal is input to the P3.

FIG. 12 is a diagram illustrating output waveforms at each port when a signal is input to a P1.

FIG. 13 is a first diagram illustrating the waveforms in the phase difference of the outputs of the P2 and the P4 when the signal is input to the P1.

FIG. 14 is a diagram illustrating an example of implementing a wide band sum & difference circuit illustrated in FIG. 9.

FIG. 15 is a first diagram illustrating a wide band sum & difference circuit in accordance with an exemplary embodiment of the present invention.

FIG. 16 is a second diagram illustrating the wide band sum & difference circuit in accordance with the exemplary embodiment of the present invention.

FIG. 17 is a third diagram illustrating the wide band sum & difference circuit in accordance with the exemplary embodiment of the present invention.

FIG. 18 is a second diagram illustrating the waveforms in the phase difference of the outputs of the P2 and the P4 when the signal is input to the P3.

FIG. 19 is a second diagram illustrating the waveforms in the phase difference of the outputs of the P2 and the P4 when the signal is input to the P1.

FIGS. 20A and 20B are diagrams illustrating an S parameter of a short stub λ/4 line according to the exemplary embodiment of the present invention.

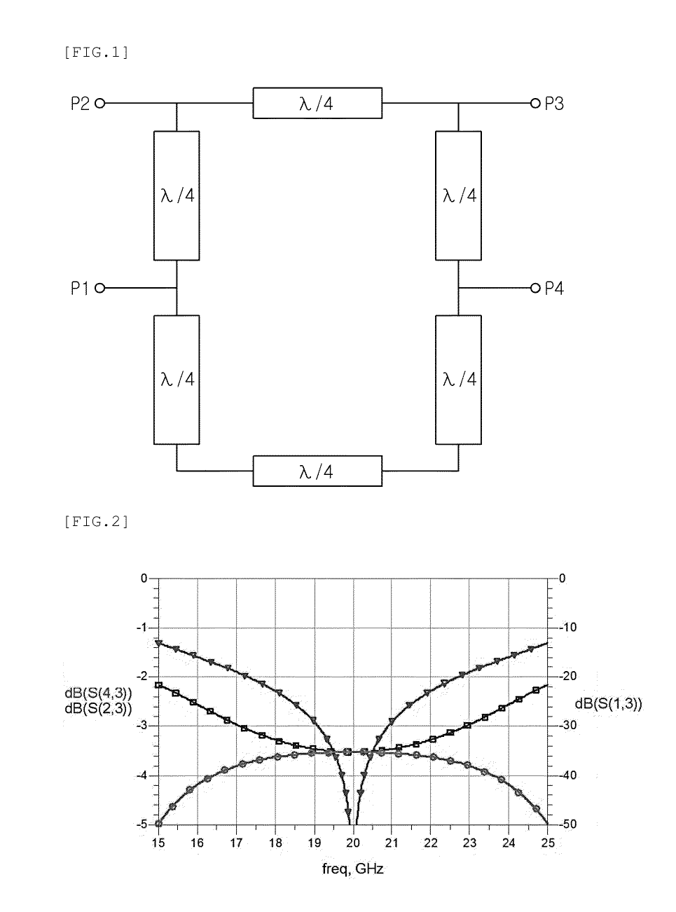

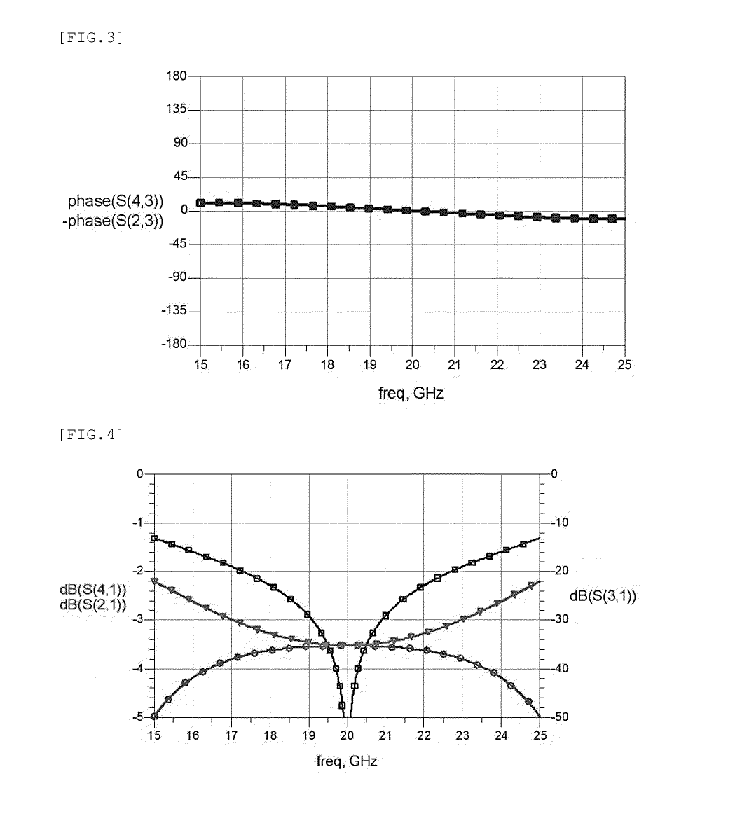

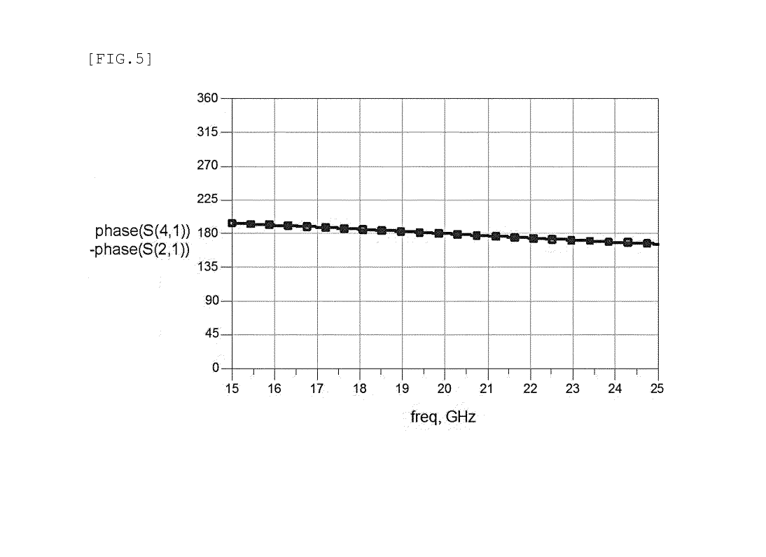

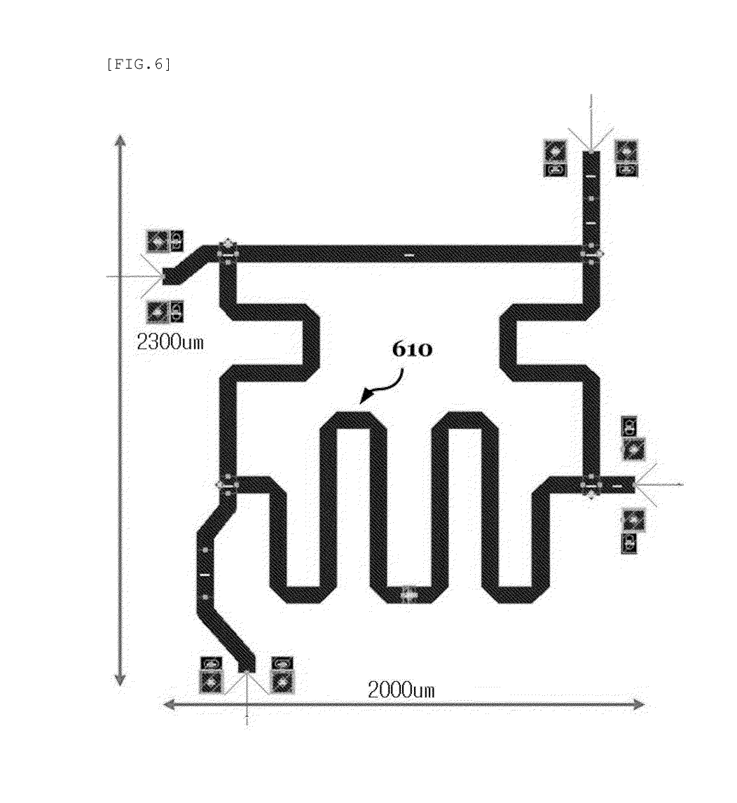

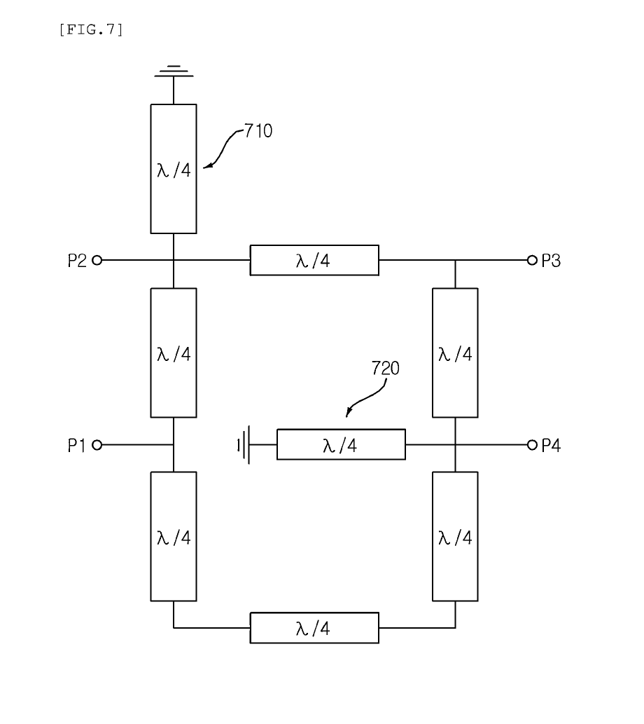

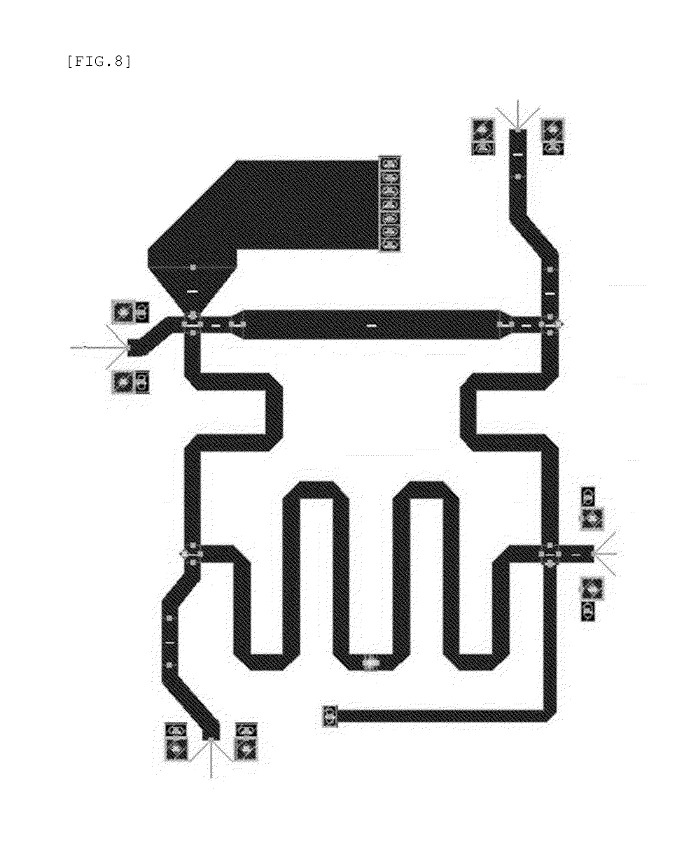

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a wide band sum & difference circuit for a monolithic microwave integrated circuit according to an exemplary embodiment of the present invention will be described with reference to FIGS. 9 to 20. Embodiments of the present invention will be described in detail based on portions necessary to understand the operations and actions of the present invention.

In descriptions of components of the present invention, different reference numerals may be used for the components of same name according to the drawings and the same reference numerals may be used for components even in different drawings. However, even in this case, it does not mean that the corresponding components have different functions according to the embodiments or it means that the corresponding components have the same function in different embodiments and the functions of each component will be determined based on the description of each component in the corresponding embodiments.

In particular, an exemplary embodiment of the present invention proposes a new structure of a wide band sum & difference circuit to be able to be operated in a wide band by including one Range coupler and one λ/4 line and further including a short stub line or a resonance circuit as needed.

FIG. 9 is a diagram illustrating a narrow band sum & difference circuit in accordance with an exemplary embodiment of the present invention.

As illustrated in FIG. 9, the narrow band sum & difference circuit according to an exemplary embodiment of the present invention may be implemented to include one Range coupler 910, one λ/4 line 920, and the like.

The Range coupler 910 may have one terminal connected to a plurality of first ports that receive signals and the other terminal connected to a plurality of second ports that output signals. In this configuration, the first port includes an input port that receives a signal and an isolated port at which the output signal is not detected when the signal is input to the input port. The second port includes a through port that outputs a predetermined ratio of input signal when a signal is input to the input port and a coupled port.

A λ/4 line 920 may be connected between one output terminal and one second port of the Range coupler 910 in series. Here, the λ/4 line 920 represents a micro strip line having a length of λ/4.

An operation principle of the configured narrow band sum & difference circuit will be described below.

1) When a signal is input to the first port P3, a wave without phase propagated to an output terminal of the Range coupler 910 reaches the second port P2 and a wave propagated at λ/4 by the λ/4 line 920 reaches the second port P2. Therefore, a wave propagated by a total of λ/4 arrives from P1 to P2. The wave propagated at λ/4 by the Range coupler 910 reaches the second port P4. The first port P3 becomes isolation at which no output is detected.

In this case, the power input to the P3 is equally distributed to the P2 and P4 halves or has the same phase (0°).

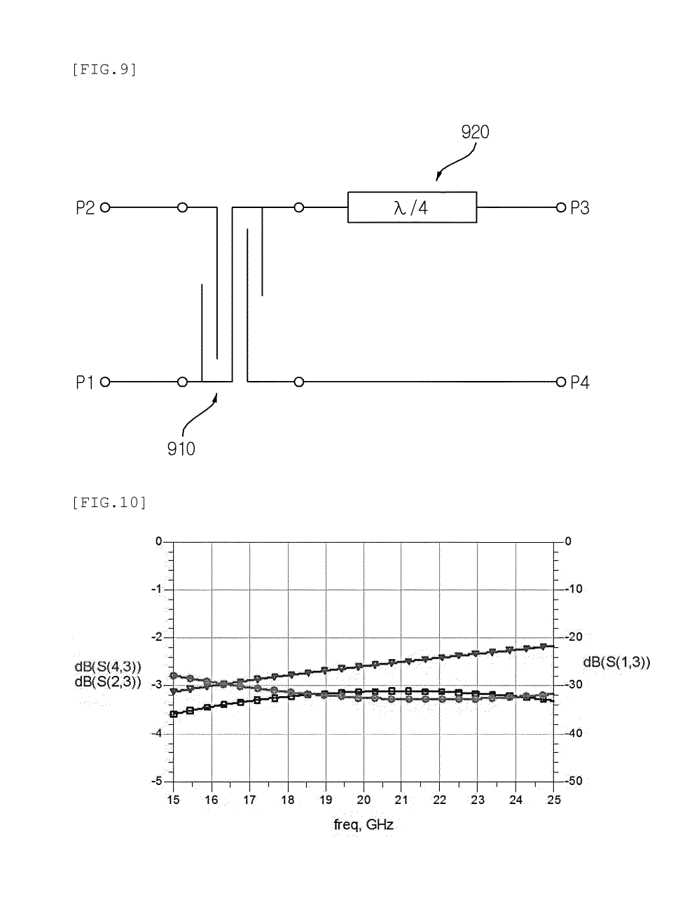

FIG. 10 illustrates the output waveforms at each port when the signal is input to the P3 and FIG. 11 illustrates the waveform having the phase difference in the outputs of the P2 and the P4 when the signal is input to the P3.

2) When the signal is input to the first port P1, a wave propagated to the output terminal of the Range coupler 910 at λ/4 reaches the second port P2 and a wave propagated at λ/4 by the λ/4 line 920 reaches the second port P2 Therefore, a wave propagated by a total of λ/2 arrives from the P1 to the P2. A wave without the phase propagation reaches the P4 due to the Range coupler 910. The port P3 becomes isolation at which no output is detected.

In this case, the power input to the first P1 is equally distributed to the P2 and P4 halves or has an antiphase (180°).

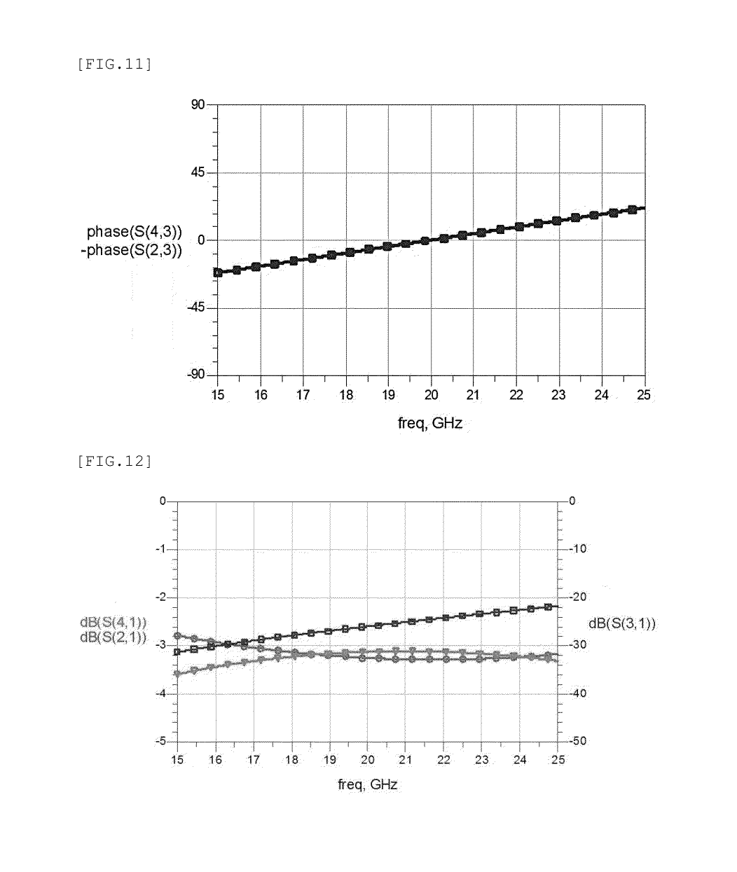

FIG. 12 illustrates the output waveforms at each port when the signal is input to the P1 and FIG. 13 illustrates the waveform having the phase difference in the outputs of the P2 and the P4 when the signal is input to the P1.

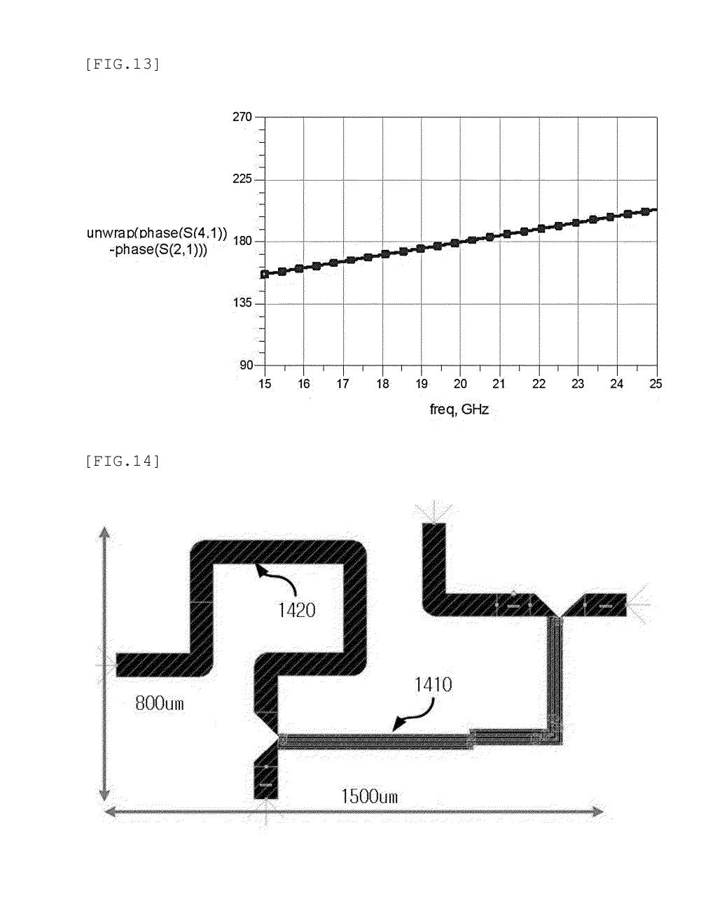

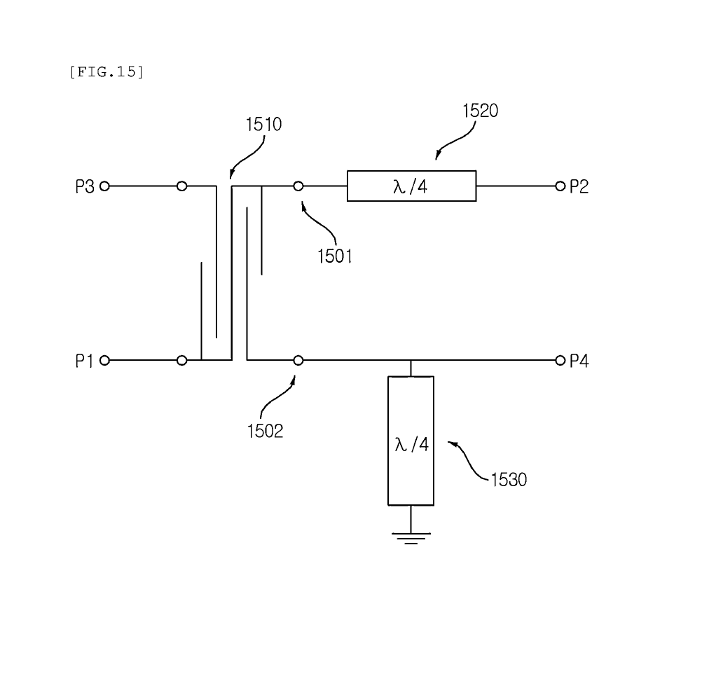

FIG. 14 is a diagram illustrating an example of implementing a sum & difference circuit illustrated in FIG. 9.

As illustrated in FIG. 14, the sum & difference circuit according to the exemplary embodiment of the present invention may be implemented as one Range coupler and one λ/4 line to remarkably reduce the circuit size while maintaining the same performance, as compared with the structure according to the related art.

FIG. 15 is a first diagram illustrating a wide band sum & difference circuit in accordance with an exemplary embodiment of the present invention.

As illustrated in FIG. 15, the wide band sum & difference circuit according to the exemplary embodiment of the present invention may be implemented to include one Range coupler 1510, one λ/4 line 1520, and one short stub λ/4 line 1530, and the like.

The Range coupler 1510 may have one terminal connected to a plurality of first ports, that is, the input port and the isolated port that receive signals and the other terminal connected to a plurality of second ports, that is, the coupled port and the through port that output signals.

The λ/4 line 1520 may be connected between one output terminal 1501 and one second port P2 of the Range coupler 1510 in series.

The short stub λ/4 line 1530 may be configured to be connected between another output terminal 1502 and another second port P4 of the Range coupler 1510 in parallel.

An operation principle of the configured wide band sum & difference circuit will be described below.

1) When a signal is input to the first port P3, a wave without phase propagated to an output terminal of the Range coupler 1510 reaches the second port P2 and a wave propagated at λ/4 by the λ/4 line 1520 reaches the second port P2. Therefore, a wave propagated by a total of λ/4 arrives from the P1 to the P2. The wave propagated at λ/4 by the Range coupler 1510 reaches the second port P4. The first port P3 becomes isolation at which no output is detected.

In this case, the power input to the P3 is equally distributed to the P2 and P4 halves or has the same phase (0°).

2) When the signal is input to the first port P1, a wave propagated to the output terminal of the Range coupler 1510 at λ/4 reaches the second port P2 and a wave propagated at λ/4 by the λ/4 line 1520 reaches the second port P2 Therefore, a wave propagated by a total of λ/2 arrives from the P1 to the P2. A wave without the phase propagation reaches the P4 due to the Range coupler 1510. The port P3 becomes isolation at which no output is detected.

In this case, the power input to the first port P1 is equally distributed to the P2 and P4 halves or has an antiphase (180°).

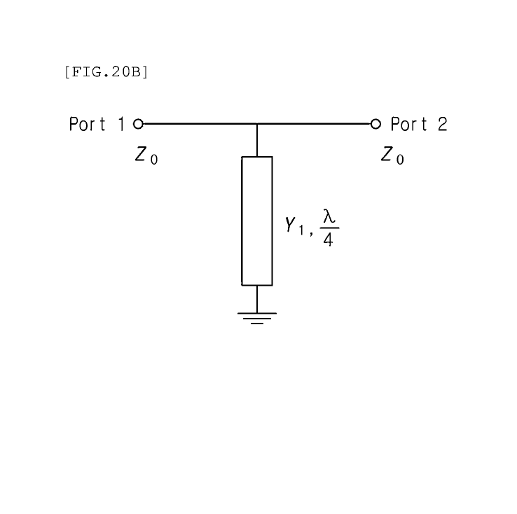

A principle of the configured sum & difference circuit operated in a wide band will be described below. FIGS. 20A and 20B are diagrams illustrating a scattering (S) parameter of a short stub λ/4 line according to the exemplary embodiment of the present invention.

As illustrated in FIG. 20A, the calculation of admittance in the λ/4 short stub may be represented by the following Equation 1.

$${Y}_{stub} = - j {Y}_{1} cot ( \frac{f \times 90 °}{{f}_{0}} ) \qquad [ Equation 1 ]$$

In the above Equation 1, Y1 represents characteristic admittance of the λ/4 short stub, f0 represents a central frequency at which the circuit is operated, and f is a real frequency.

As illustrated in FIG. 20B, a calculation of a through coefficient S21 of a 2-port network connected with the λ/4 short stub in parallel based on the Equation 1 may be represented by the following Equation 2.

$${S}_{21} = \frac{2 {Y}_{0}}{2 {Y}_{0} - j {Y}_{1} cot \frac{f \times 90 °}{{f}_{0}}} \qquad [ Equation 2 ]$$

In the above Equation 2, Y0 represents characteristic impedance at front and back stages connected with the λ/4 short stub in parallel.

A calculation of a phase changing rate according to a frequency based on the S parameter when the λ/4 short stub is connected in parallel may be represented by the following Equation 3.

$$\frac{d }{d f} ( ∠ {S}_{21} ) = \frac{{Z}_{0} \times 45 °}{{Z}_{1} \times {f}_{0}} \qquad [ Equation 3 ]$$

In the above Equation 3, Z0=1/Y0 and Z1=1/Y1.

Meanwhile, a calculation of the phase changing rate according to the frequency at the transmission lines having a phase length of θx connected in series may be represented by the following Equation 4.

$$\frac{d }{d f} ( ∠ {S}_{21 \cdot line} ) = \frac{{θ}_{x}}{{f}_{0}} \qquad [ Equation 4 ]$$

In the above Equation 4, S21.line and θx each represent a transfer scattering coefficient S21 at the transmission lines connected in series and an electrical length of the transmission line and f0 represents a central frequency at which the circuit is operated.

Therefore, if it is assumed that the phase changing rate when the stub is connected in parallel is equal to the phase changing rate at the transmission line having a phase length of θx, the following Equation 5 may be induced from the above Equations 3 and 4.

$${Z}_{1} = \frac{{Z}_{0} \times 45 °}{{θ}_{x}} \qquad [ Equation 5 ]$$

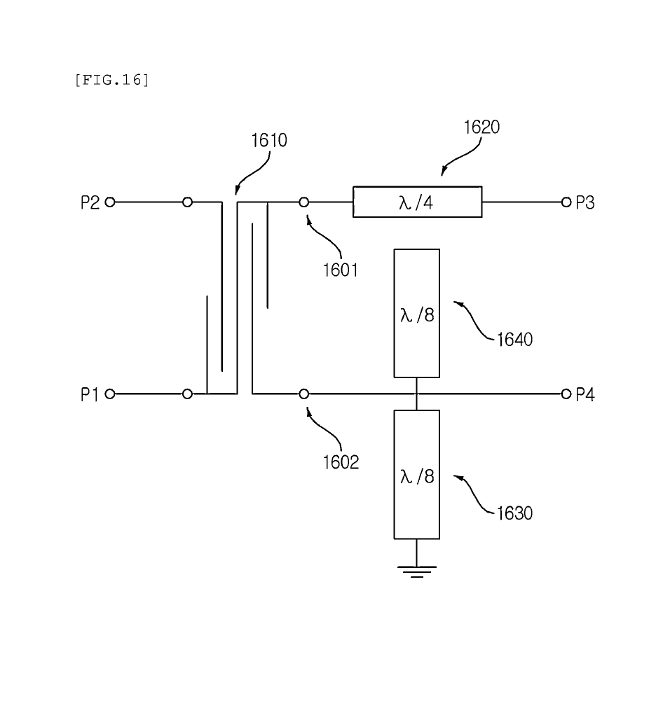

FIG. 16 is a second diagram illustrating the wide band sum & difference circuit in accordance with the exemplary embodiment of the present invention.

As illustrated in FIG. 16, the wide band sum & difference circuit according to the exemplary embodiment of the present invention may be implemented to include one Range coupler 1610, one λ/4 line 1620, and one short stub λ/8 line and one open stub λ/8 line 1630 and 1640, and the like.

The Range coupler 1610 may have one terminal connected to a plurality of first ports, that is, the input port and the isolated port that receive signals and the other terminal connected to a plurality of second ports, that is, the coupled port and the through port that output signals.

A λ/4 line 1620 may be connected between one output terminal and one second port P2 of the Range coupler 1610 in series.

The short stub λ/8 line and the open stub λ/8 lines 1630 and 1640 may be configured to be connected between another output terminal 1602 and another second port P4 of the Range coupler 1610 in parallel.

An operation principle of the configured wide band sum & difference circuit will be described below.

1) When a signal is input to the first port P3, a wave without phase propagated to an output terminal of the Range coupler 1610 reaches the second port P2 and a wave propagated at λ/4 by the λ/4 line 1620 reaches the second port P2. Therefore, a wave propagated by a total of λ/4 arrives from the P1 to the P2. The wave propagated at λ/4 by the Range coupler 1610 reaches the second port P4. The first port P3 becomes isolation at which no output is detected.

In this case, the power input to the P3 is equally distributed to the P2 and P4 halves or has the same phase (0°).

2) When the signal is input to the first port P1, a wave propagated to the output terminal of the Range coupler 1610 at λ/4 reaches the second port P2 and a wave propagated at λ/4 by the λ/4 line 1620 reaches the second port P2. Therefore, a wave propagated by a total of λ/2 arrives from the P1 to the P2. A wave without the phase propagation reaches the P4 due to the Range coupler 1610. The port P3 becomes isolation at which no output is detected.

In this case, the power input to the P1 is equally distributed to the P2 and P4 halves or has an antiphase (180°).

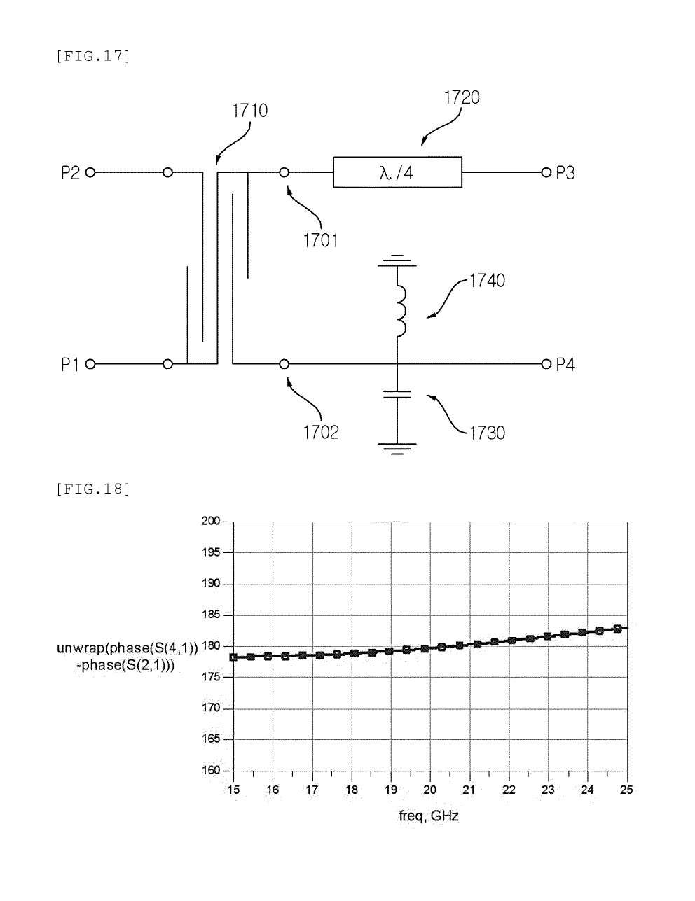

FIG. 17 is a third diagram illustrating the wide band sum & difference circuit in accordance with the exemplary embodiment of the present invention.

As illustrated in FIG. 17, the wide band sum & difference circuit according to the exemplary embodiment of the present invention may be implemented to include one Range coupler 1710, one λ/4 line 1720, and one resonance circuits 1730 and 1740, and the like.

The Range coupler 1710 may have one terminal connected to a plurality of first ports, that is, the input port and the isolated port that receive signals and the other terminal connected to a plurality of second ports, that is, the coupled port and the through port that output signals.

The λ/4 line 1720 may be connected between one output terminal 1701 and one second port P2 of the Range coupler 1710 in series.

The resonance circuits 1730 and 1740 may be configured to be connected between another output terminal 1702 and another second port P4 of the Range coupler 1710 in parallel.

In this case, the resonance circuit is implemented as an LC parallel resonance circuit and a capacitor 1730 and an inductor 1740 may be connected between the output terminal 1702 of the Range coupler 1710 and the second port P4 in parallel.

An operation principle of the configured wide band sum & difference circuit will be described below.

1) When a signal is input to the first port P3, a wave without phase propagated to an output terminal of the Range coupler 1710 reaches the second port P2 and a wave propagated at λ/4 by the λ/4 line 1720 reaches the second port P2. Therefore, a wave propagated by a total of λ/4 arrives from the P1 to the P2. The wave propagated at λ/4 by the Range coupler 1710 reaches the second port P4. The first port P3 becomes isolation at which no output is detected.

In this case, the power input to the P3 is equally distributed to the P2 and P4 halves or has the same phase (0°).

2) When the signal is input to the first port P1, a wave propagated to the output terminal of the Range coupler 1710 at λ/4 reaches the second port P2 and a wave propagated at λ/4 by the λ/4 line 1720 reaches the second port P2. Therefore, a wave propagated by a total of λ/2 arrives from the P1 to the P2. A wave without the phase propagation reaches the P4 due to the Range coupler 1710. The port P3 becomes isolation at which no output is detected.

In this case, the power input to the first port P1 is equally distributed to the P2 and P4 halves or has an antiphase (180°).

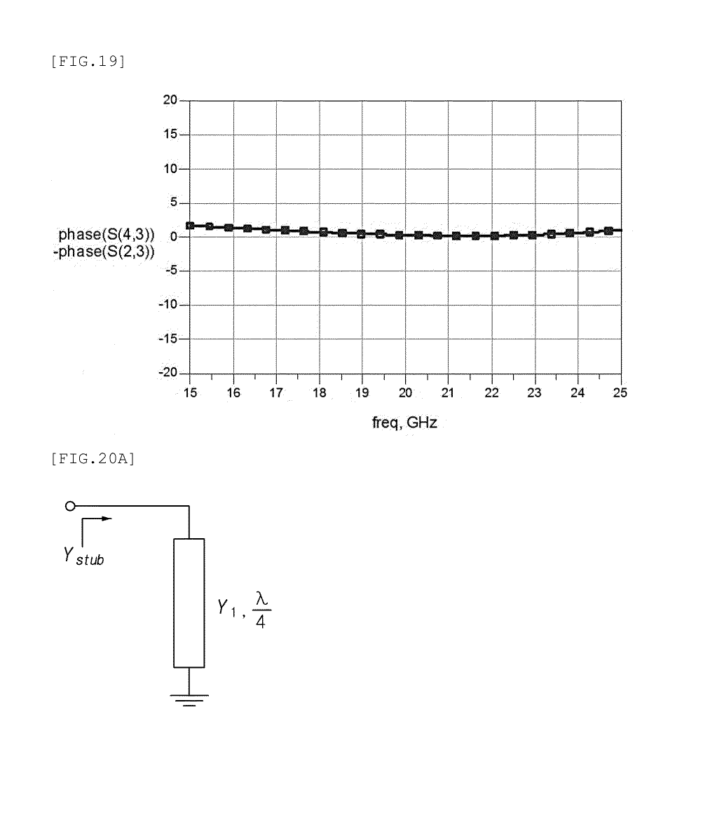

FIG. 18 illustrates the waveforms in the phase difference of the outputs of the P2 and the P4 when the signal is input to the P3 and FIG. 19 illustrates the waveforms in the phase difference of the outputs of the P2 and the P4 when the signal is input to the P1.

That is, it can be confirmed that the wide band sum & difference circuit to which the structure according to the exemplary embodiment of the present invention is applied may be operated up to an octave band having a phase error of 2° or so in a total band, as compared with FIGS. 11 and 13.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A wide band sum & difference circuit for a monolithic microwave integrated circuit, comprising:
a Range coupler having one terminal connected to a plurality of first ports that receive a signal and the other terminal connected to a plurality of second ports that output signals;
one λ/4 line that is connected between one output terminal and one second port of the Range coupler in series; and
one short stub λ/4 line that is connected with the other output terminal and the other second port of the Range coupler in parallel.

2. The wide band sum & difference circuit of claim 1, wherein the first port includes:
an input port that receives the signal; and
an isolated port at which no output signal is detected when the signal is input to the input port.

3. The wide band sum & difference circuit of claim 1, wherein the second port includes:
a through port that outputs a predetermined ratio of the input signal when the signal is input to the input port; and
a coupled port that outputs the predetermined ratio of the input signal when the signal is input to the input port.

4. The wide band sum & difference circuit of claim 1, wherein the short stub λ/4 line is substituted into one short stub λ/8 line and one open stub λ/8 line that are connected between the other output terminal and the other second port of the Range coupler in parallel.

5. The wide band sum & difference circuit of claim 1, wherein the short stub λ/4 line is substituted into a resonance circuit that is connected between the other output terminal and the other second port of the Range coupler in parallel.

6. The wide band sum & difference circuit of claim 5, wherein the resonance circuit is an LC parallel resonance circuit.

7. The wide band sum & difference circuit of claim 1, wherein power input to any one of the plurality of first ports is equally distributed to each of the two of the plurality of second ports halves and has the same phase (0°) or an antiphase (180°).
